(19) United States
(12) Patent Application Publication
(10) Pub. No.: US 2002/0136337 A1
(43) Pub. Date: Sep. 26, 2002

(54) Method and apparatus for high-resolution jitter measurement

(76) Inventors: Abhijit Chatterjee, Marietta, GA (US); Sasikumar Cherubal, Atlanta, GA (US)

Correspondence Address: Garth Janke, BIRDWELL, JANKE & DURANDO, PLC, Suite 1400, 1100 SW Sixth Avenue, Portland, OR, 97204, US

(21) Appl. No.: 10/101,784

(22) Filed: Mar. 19, 2002

Related U.S. Application Data
(60) Provisional application No. 60/277,704, filed on Mar. 20, 2001.

(51) Int. Cl. H04L 7/00

(52) U.S. Cl. 375/355; 375/371

(57) ABSTRACT

A method and apparatus for high-resolution jitter measurement. A signal generating circuit produces a period reference signal and applies the reference signal to a sampling input of an ADC. An output signal of a DUT is coupled to a clock input of the ADC, and the frequency of the reference signal is set to be equal to the frequency of the output signal of the DUT plus a fixed offset such that the code output provides a digital representation of a beat signal. The beat signal is defined by discrete sampling points representing at least ten periods of the beat signal. Each period of the beat signal comprises a respective subset of the sampling points, wherein the sampling points of each of the subsets correspond to unique sampling phases that are defined similarly for each of the periods of the beat signal by the offset. The sampling points of each of the subsets are subject to variation from the corresponding sampling phases as a result of the jitter. A jitter analyzing circuit is adapted to associate the subsets of sampling points with the corresponding periods and to compare the sampling point associated with one of the periods at a selected one of the sampling phases with the sampling points associated with each of the other periods associated with the same selected one of the sampling phases to produce a distribution of the sampling points associated with the selected one of the sampling phases, the width of the distribution being representative of the amount of the jitter.

### RELATED APPLICATIONS

The present application claims the benefit of the inventor's U.S. provisional application, Serial No. 60/277,704, filed Mar. 20, 2001, which is incorporated by reference herein in its entirety.

### FIELD OF THE INVENTION

The present invention relates to a method and apparatus for high-resolution jitter measurement. More particularly, the invention relates to such a method and apparatus employing an analog-to-digital converter (“ADC”).

### BACKGROUND OF THE INVENTION

With increasing speeds of digital circuits and transmission systems, jitter in clock and I/O signals is becoming a larger portion of the available timing margins. This imposes stringent conditions on the allowable jitter in these signals. Therefore, accurate jitter measurements are becoming an increasingly important aspect of production testing of high-speed digital and mixed-signal IC's. “Timing jitter” as used herein is defined by the International Telecommunications Union as “the short-term variation in the significant points of a digital signal from their ideal points in time.” Other types of jitter are “period jitter,” defined as the variation of the period of a signal from the average period, and “cycle-to-cycle jitter,” defined as the variation in the period of a signal from one period to the next.

Jitter specifications for most high-speed digital transmission systems, such as ‘firewire’ (IEEE 1394) is in the 100-200 picosecond range. To measure jitter in this range accurately, the maximum error in the measurement system must be less than a few picoseconds. This is a stringent requirement on the instruments employed for measuring jitter. For example, typical noise floors for jitter measurement in prior art Automatic Test Equipment (“ATE”) used for testing IC's in the production environment is in the range of 10-50 ps. However, this is insufficient for high-speed IC's which have jitter specification limits in the same range.

Jitter measurements have commonly been made using Time Interval Analyzers, which measure time intervals using (1) counters and interpolators or (2) vernier methods using two oscillators of slightly different frequency. A disadvantage of these methods is that long test times are required to obtain the number of jitter samples required to provide statistically significant measurements.

Phase interpolation and digitization techniques using delay lines or delay-locked loops provide additional known means for measuring time intervals. A disadvantage with such means is that they tend to have poor resolution due to the integral non-linearity of the delay lines.

Methods have been proposed for jitter measurement using sampling oscilloscopes. However, these techniques require sampling rates that are several times that of the frequency of the signal being tested, which can only be achieved using expensive, stand-alone, high-performance oscilloscopes which result in long test times and are therefore not suitable for the production test environment.

Several Built-In-Self-Test (“BIST”) techniques have also been proposed to measure jitter; however, the additional silicon overhead of BIST may not be feasible for all applications, and the addition of BIST circuitry may degrade circuit performance.

There have been several methods proposed in the literature for measuring internal aperture jitter in ADC's. These techniques measure jitter in the sampling instants of an ADC. Therefore, if the input clock to the ADC has some jitter, these techniques measure the sum of the clock jitter and the ADC aperture jitter.

The classical method for measuring ADC aperture jitter uses a locked histogram test where the signal frequency is set to an integer multiple of the clock frequency. This results, for zero jitter, in the same phase of the input signal being sampled at every clock edge. Therefore, any variation in the output codes of the ADC can be related to the jitter in the sampling instants of the ADC. However, this technique is highly sensitive to the sampling phase of the input signal. Since the error due to jitter is proportional to the slope of the input signal which, in turn, depends on the sampling phase, poor results will be obtained if the input sine wave is sampled near its peak.

Langard et al. (“An Improved Method of ADC Jitter Measurement,” International Test Conference 1994) (“Langard”) have proposed an improved technique for characterizing aperture jitter in an ADC. A sine wave is input to the ADC, and a periodic digital clock signal is used to clock the ADC. The frequency of the clock signal is offset slightly from the frequency of the sine wave so that a beat signal is produced which is represented at the output of the ADC. Two periods of the beat signal are obtained that are represented by corresponding pairs of sampling points. The pairs of sampling points are samples of the sine wave taken at two different times at the same phase or “sampling phase.” If there is no jitter and no other ADC error, the two sampling points of each pair will have the same value; however, if there is jitter or other ADC error, the sampling points will have different values. The amount of the difference therefore reflects the amount of aperture jitter or other ADC error.

The slope of the sine wave at a particular sampling phase produces a gain at the output of the ADC. The slope of the sine wave is maximum at 0 and 180 degrees, and is zero at 90 and 270 degrees. Accordingly, this gain is maximum at sampling phases of 0 and 180 degrees, and is essentially zero at sampling phases of 90 and 270 degrees. Where the gain is small or zero, the output of the ADC is insensitive to errors in phase, such as would be caused by aperture jitter. Accordingly, where the gain is zero, any difference in the values of the two points at that sampling phase is due to non-phase related error. On the other hand, where the gain is maximum, the error includes both phase and non-phase related error.

Langard proposes to compare the values of the points in each pair of points at each sampling phase to obtain error amplitudes. The error amplitudes are smallest where the aforementioned gain is smallest and can therefore be identified and distinguished from the error amplitudes corresponding to sampling phases far from 90 and 270 degrees. These minimum error amplitudes are presumed to be non-aperture jitter related and are subtracted from the error amplitudes at other sampling phases having higher gains, to estimate aperture jitter. The error amplitudes corrected for non-aperture jitter related errors are further corrected to account for the gain or slope of the sine wave at the sampling phase to obtain estimates of the aperture jitter.

In Langard, the digital clock signal is desired to be as jitter-free as practical. However, it is understood that the clock signal has jitter associated therewith, so that the estimate of aperture jitter includes this clock jitter. Accordingly, it is desired to minimize jitter from the clock signal so that the aperture jitter of the ADC can be isolated. The Langard method has not been used to measure jitter produced by an external device whose jitter is to be measured or characterized. Such an external device is referred to herein as a “device-under-test” or DUT.

Accordingly, there is a need for a method and apparatus for high-resolution jitter measurement that increases the speed and accuracy of jitter measurement, and which is suitable for use in the production environment.

### SUMMARY OF THE INVENTION

Disclosed is a method and apparatus for high-resolution jitter measurement. Within the scope of the invention, there is an apparatus for measuring jitter in an output digital signal of a DUT that comprises an ADC, a signal generating circuit for producing a periodic reference signal, such as a sine wave, and applying the reference signal to a sampling input of the ADC, and a jitter analyzing circuit. The output signal of the DUT is coupled to a clock input of the ADC, and the frequency of the reference signal is set to be equal to the frequency of the output signal of the DUT plus a fixed offset such that the sampling output provides a digital representation of a beat signal. The beat signal is defined by discrete sampling points representing at least ten periods of the beat signal. Each period of the beat signal comprises a respective subset of the sampling points, wherein the sampling points of each of the subsets correspond to unique sampling phases that are defined similarly for each of the periods of the beat signal by the offset. The sampling points of each of the subsets are subject to variation from the corresponding sampling phases as a result of the jitter. The jitter analyzing circuit is adapted to associate the subsets of sampling points with the corresponding periods and to compare the sampling point associated with one of the periods at a selected one of the sampling phases with the sampling points associated with each of the other periods associated with the same selected one of the sampling phases to produce a distribution of the sampling points associated with the selected one of the sampling phases, the width of the distribution being representative of the amount of the jitter.

Preferably, the jitter analyzing circuit is further adapted to correct the jitter determined as described above for non-linearity of the ADC by making use of the results of a histogram test of the ADC for characterizing the non-linearity.

Therefore, it is an object of the present invention to provide a novel and improved method and apparatus for high-resolution jitter measurement.

It is another object of the present invention to provide such a method and apparatus that provides for increased speed.

It is still another object of the present invention to provide such a method and apparatus that provides for increased accuracy.

It is yet another object of the present invention to provide such a method and apparatus that is suitable for use in a production environment.

The foregoing and other objects, features and advantages of the present invention will be more readily understood upon consideration of the following detailed description of the invention, taken in conjunction with the following drawings.

### BRIEF DESCRIPTION OF THE DRAWINGS

FIG. 1 is a schematic of a jitter measurement apparatus employing an ADC according to the present invention.

FIG. 2 is a plot illustrating the production of a beat signal for use in the present invention.

FIG. 3 is a plot illustrating a series of jitter distributions corresponding to unique sampling phases according to the present invention.

FIG. 4 shows part of the transfer characteristic of an ADC with non-linearity.

### DETAILED DESCRIPTION OF A PREFERRED EMBODIMENT

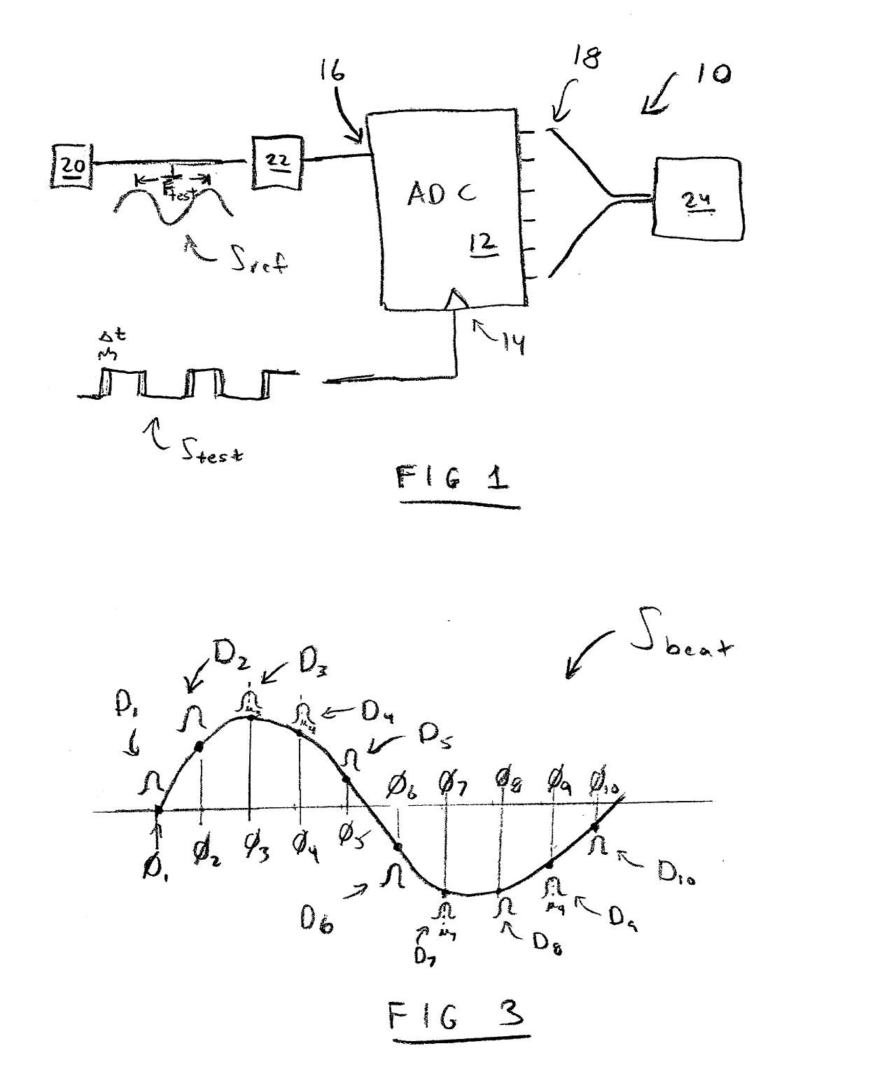

Referring to FIG. 1, an apparatus 10 according to the present invention for producing a high-resolution jitter measurement is shown. An outstanding feature of the apparatus 10 is that it is adapted for use in measuring the jitter of a periodic digital signal Sₜₑₛₜ output from a device-under-test (“DUT”) in, preferably, a production test environment. It is presumed, therefore, that there may be a significant degree of jitter Δt in the signal Sₜₑₛₜ and it is not desired to minimize this jitter or select the signal Sₜₑₛₜ according to the amount of jitter. The signal Sₜₑₛₜ has a fundamental frequency Fₜₑₛₜ and phase/timing variations associated with the jitter.

The apparatus 10 includes an ADC 12 having a clock input 14, a sampling input 16, and a code output 18. The ADC is preferably selected to have an aperture jitter that is much less than the jitter in the signal Sₜₑₛₜ.

The apparatus 10 also includes a circuit 20 for generating an analog reference signal S_{ref}. The reference signal is preferably a sine wave that is as free from phase noise and jitter as is practical; however, any substantially continuous, periodic signal may be employed without departing from the principles of the invention. The sine wave is preferred due to the ease of generating sine waves at high frequencies. The reference signal output from the circuit 20 is preferably applied to a narrow band-pass filter 22 to further refine the clarity of the reference signal.

The reference signal S_{ref} is provided to the sampling input 16 of the ADC, and the test signal Sₜₑₛₜ output from the DUT is provided to the clock input 14. Either the leading or the trailing edge of the test signal triggers the ADC to sample the reference signal. If the frequency of the test signal is perfectly equal to the frequency of the reference signal, the code output 18 of the ADC would provide a digital representation of the reference signal S_{ref}. Error in the output of the ADC at any particular point due to jitter will be equal to the width of the jitter (Δt) multiplied by the slope of the reference signal at that point.

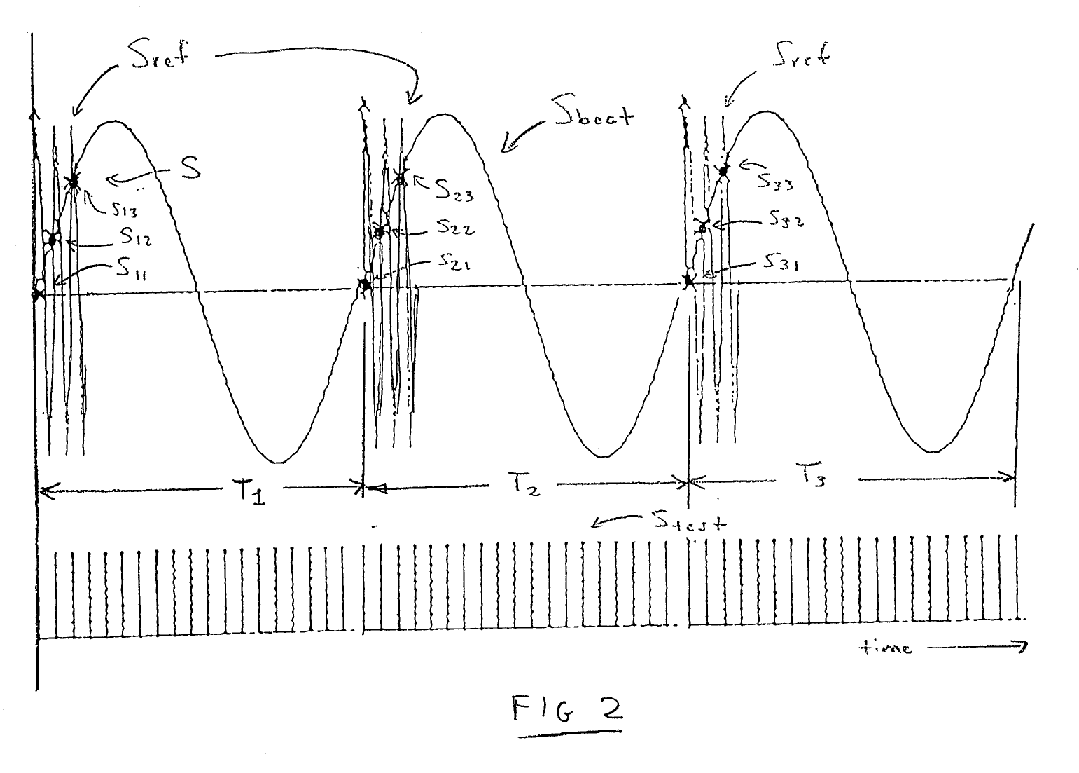

Turning to FIG. 2, if the frequencies of the test and reference signals differ by a fixed amount, the ADC produces a beat signal S_{beat}. Production of the beat signal ensures that the reference signal is sampled over all phases (“sampling phase”). Jitter in the test signal does not affect the beat signal; however, the jitter does produce variance in the sampling phase for the sampling points “S.” The sampling points S may be defined as being associated with a given period T of the beat signal and a given nominal sampling phase φ (“S_{Tφ}”).

For example, a sampling point S_{Tφ} (S=1, φ=1) or S₁₁ is taken at a sampling phase φ₁ of a first period T₁ of the beat signal S_{beat}; a sampling point S₁₂ is taken at a sampling phase φ₂ of the first period T₁ of the beat signal; a sampling point S₁₃ is taken at a sampling phase φ₃ of the first period T₁ of the beat signal, and so on, where the sampling phases φ₁, φ₂, and φ₃ as shown in FIG. 2 are roughly about 0, π/8, and π/4 radians. For N total sampling points of the beat signal and k periods T, there are N/k of the points P₁ and the sampling phases are separated by 2πk/N radians. Similarly, for a second period T₂ of the beat signal, there are corresponding sampling points S₂₁, S₂₂, S₂₃, . . . S_{2(N/k)}; for a third period T₃ of the beat signal, there are corresponding sampling points S₃₁, S₃₂, S₃₃, . . . S_{3(N/k)}, and so on.

According to the invention, k is an integer that is at least ten, so that at least ten and preferably more periods T of the beat signal are obtained from the ADC output 18 to provide a statistically meaningful number of sampling points S corresponding to a given sampling phase (S_{φ}).

The k sampling points S_{Tφ} for each sampling phase φ are associated with one another by a jitter analyzing circuit 24 (FIG. 1) coupled to the output 18 of the ADC. The jitter analyzing circuit may be implemented in dedicated hardware or as a programmed computer. The actual phase of the sampling points varies around a mean for that sampling phase according to a distribution. Referring to the foregoing discussion of Langard, jitter in an ADC is assumed to be independent, i.e., the jitter varies randomly and the distribution is gaussian; however, in at least some devices, jitter is not independent and the sampling points S_{φ} corresponding to a given sampling phase may have a bias or may not have a gaussian distribution.

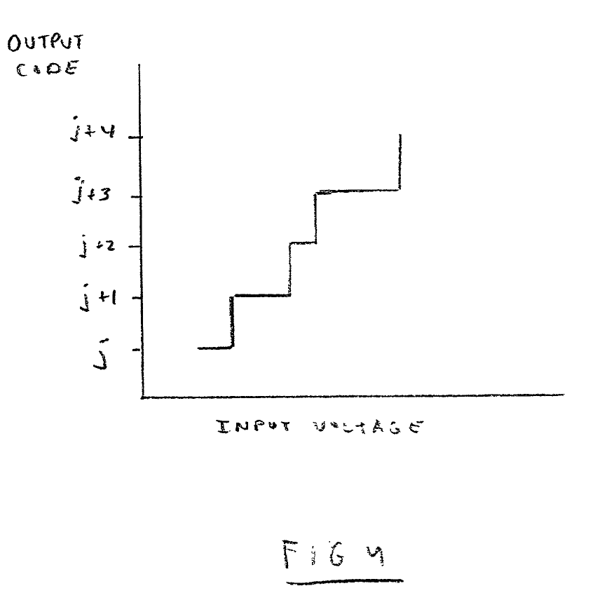

Turning to FIG. 3, for k periods of the beat signal S_{beat}, there are N/k sampling phases φ and N/k distributions “D_{φ},” where N/k=10 in FIG. 3. Each of the distributions “D_{φ}” can be characterized by a mean μ and a standard deviation σ, wherein the standard deviation can be related to the time interval over which jitter has occurred. The distributions represent the number of occurrences of various output codes of the ADC at the respective sampling phase. The distributions can be used without further processing for estimating jitter.

To obtain numeric estimates of jitter, the distributions can be normalized with respect to their mean values, to obtain samples E_{φ}[i]=S_{φ}[i]−μ_{φ}, where E_{φ}[i] is the error in the output code, at a given sampling phase φ, for the ith sample S_{φ}[i] in the distribution. The error measurements E[i] are related to jitter Δt by

Δt[i]_{φ}=E_{φ}[i]/[d(S_{ref})/dt]_{φ}, (1)

where Δt[i], is the estimate of jitter derived from the ith sample S_{φ}[i] in the distribution corresponding to the sampling phase φ. Equation (2) assumes that the change in slope of the reference signal over the jitter times associated with the distributions is negligible. Once the distributions are converted to samples Δt[i] of the jitter, they can be combined into one distribution if desired. Preferably, however, the distributions corresponding to sampling phases that have very low or zero slope are discarded. This is because, as mentioned, these sampling phases are relatively insensitive to phase-related errors such as jitter. For example, sampling phases between (π/2+/−π/4) and (3π/2+/−π/4) are preferably discarded according to the present invention because the error measurements in the distributions corresponding to these sampling phases are relatively insensitive to the jitter that it is desired to measure.

The information processed as needed by the jitter analyzing circuit 24 may be printed or displayed so that a test operator may judge whether the jitter is within specification limits, or may be used as part of an analysis conducted in the jitter analyzing circuit. For example, pass/fail test limits may be provided to the operator or to the jitter analyzing circuit who/which compares the maximum width of one or more of the histograms to the test limits to determine whether the DUT meets jitter specifications. Rather than produce a complete distribution or histogram, the jitter analyzing circuit may be adapted merely to identify and output the maximum jitter, and other, alternative uses for the error measurements are contemplated by the invention.

An assumption underlying the determination of the jitter estimates Δt[i] is that the ADC linearly relates changes in input voltage to changes in output code. Nonlinearity in the ADC 12 will be much higher than the specified DC nonlinearity due to factors such as harmonic distortion and signal-dependent delay in the input track/hold, and the settling time of the amplifiers. The relationship between ADC non-linearity and jitter measurement is illustrated in FIG. 4. FIG. 4 shows a part of the transfer characteristic of the ADC 12. It can be seen that the input change required to change the output code from “j+2” to “j+3” is smaller than average and the input voltage change required to change the output code from “j+3” to “j+4” is larger than average.

This non-linearity of the ADC affects the jitter measurement as follows: If jitter causes the output code to change from “j+1” to “j+2,” where the amount of voltage change required to change the code is less than average, it will appear as though the jitter is larger than it actually is. Conversely, if jitter causes the output code to change from “j+3” to “j+4,” where the amount of voltage change required to change the code is greater than average, it will appear as though the jitter is smaller than it actually is. Rather than employ information from the distributions at sampling phases that are relatively insensitive to jitter to adduce the effect of ADC nonlinearity on jitter measurement such as in Langard, this non-linearity is preferably measured and taken into account in the present invention.

More particularly, the non-linearity of the ADC 12 is measured using a histogram test. In this test, a second reference signal S_{ref2} is applied to the input 14 of the ADC that has a frequency F_{ref2} that is different, but close to, that used for the reference signal S_{ref} used to obtain the error measurements, and has the same amplitude.

The frequency and test length are chosen so that a sufficient number of samples N2 of all the codes of the ADC are obtained, as is typical in histogram testing of ADC's. More particularly, the frequency of the signal S_{ref2} is set to an integer multiple of the frequency of the clock signal (f_{c}) plus or minus f_{c}/k1, and the N2 samples are taken such that k1 is the closest integer to N/k that is relatively prime to N2. The number of samples N2 is chosen to be sufficiently large to obtain a large number (e.g., 50-200) of samples of all the output codes of the ADC.

The number of samples of each code obtained in the histogram will be (1) directly proportional to the “width” of each code and (2) inversely proportional to the slope of the S_{ref2} signal at each code span.

A cumulative histogram is computed from the histogram, and the cumulative histogram is normalized by the total number of samples in the histogram to obtain a cumulative probability distribution function (“CDF”) of the output codes of the ADC 12:

CDF[i]=Σ(j=0 to k)cⱼ/Σ(j=0 to 2ⁿ−1)cⱼ (2)

where cⱼ is the number of occurrences of code j and n is the number of bits of resolution of the ADC.

The CDF at a given code represents the fraction of the total test time that the output code of the ADC is expected to be less than the given code. Therefore, the difference between the value of the CDF at two different codes represents the expected fraction of the total test time spent changing from one code to the next. The S_{ref2} signal rises from its minimum value to its maximum value in half a period, so the time required of the input signal to change the output of the ADC from one code to the next is estimated by the difference in the value of the CDF for the two codes multiplied by half the period of the sine wave.

To compute jitter values that are corrected for ADC nonlinearity, the means μ_{φ} of the aforementioned distributions “D” obtained with the reference signal S_{ref} are converted to corresponding CDF values obtained with the signal S_{ref2} using linear interpolation between codes, and the jitter values Δt[i]_{φ} for the ith sample in the distribution corresponding to the sampling phase φ are computed from:

Δt[i]_{φ}=(CDF[i]−CDF[μ_{φ}])/2F_{ref} (3)

It is to be recognized that, while a particular method and apparatus for high-resolution jitter measurement has been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. An apparatus for measuring jitter in an output digital signal of a DUT, the apparatus having an input and an output and comprising:
an ADC having a clock input, a sampling input, and a code output for providing a digital representation of a signal present at said sampling input;
a signal generating circuit for producing a periodic reference signal at an output thereof coupled to said sampling input; and
a jitter analyzing circuit coupled to said code output, the output signal of the DUT being coupled to said clock input, and the frequency of said reference signal being set to be equal to the frequency of the output signal of the DUT plus a fixed offset such that said code output provides a digital representation of a beat signal comprising discrete sampling points representing at least ten periods thereof, each period comprising a respective subset of said sampling points, wherein the points of each of said subsets correspond to unique sampling phases defined by said offset are subject to variation therefrom as a result of the jitter, said jitter analyzing circuit being adapted to associate the subsets of sampling points with the corresponding said periods and to compare the sampling point associated with one of said periods at one of said sampling phases with the sampling points associated with each other of said periods associated with the same one of said sampling phases to produce a distribution of the sampling points associated with said one of said sampling phases, the width of said distribution being representative of the amount of the jitter.

2. The apparatus of claim 1, wherein said offset is equal to +/−N/k multiplied by the frequency of the output signal of the DUT, where N is the total number of said sampling points and k is the number of said periods of said beat signal, so that N/k represents the number of said sampling phases.

3. The apparatus of claim 1, wherein said jitter analyzing circuit is further adapted to determine the mean of said distribution and to take the difference between said mean and each of the sampling points in said distribution, to produce a set of error measurements representing the amount of the jitter.

4. The apparatus of claim 3, wherein said jitter analyzing circuit is further adapted to multiply said error measurements by a factor correcting for the slope of said beat signal at said one of said sampling phases and thereby converting said error measurements to numeric jitter measurements.

5. The apparatus of claim 1, wherein said jitter analyzing circuit is further adapted to determine the mean of said distribution and to subtract said mean from the value of a cumulative probability distribution function obtained for said ADC at said one of said sampling phases.

6. A method for measuring jitter in an output digital signal of a DUT, comprising the steps of:
providing an ADC having a clock input, a sampling input, and a code output for providing a digital representation of a signal present at said sampling input;
generating a periodic reference signal;
applying said reference signal to said sampling input;
applying the output signal of the DUT to said clock input;
setting the frequency of said reference signal to be equal to the frequency of the output signal of the DUT plus a fixed offset such that said code output provides a digital representation of a beat signal comprising discrete sampling points representing at least ten periods thereof, each period comprising a respective subset of said sampling points, wherein the points of each of said subsets correspond to unique sampling phases defined by said offset are subject to variation therefrom as a result of the jitter;
associating the subsets of sampling points with the corresponding said periods and;
comparing the sampling point associated with one of said periods at one of said sampling phases with the sampling points associated with each other of said periods associated with the same one of said sampling phases to produce a distribution of the sampling points associated with said one of said sampling phases, the width of said distribution being representative of the amount of the jitter.

7. The method of claim 6, further comprising setting said offset to be equal to +/−N/k multiplied by the frequency of the output signal of the DUT, where N is the total number of said sampling points and k is the number of said periods of said beat signal, so that N/k represents the number of said sampling phases.

8. The method of claim 6, further comprising determining the mean of said distribution and taking the difference between said mean and each of the sampling points in said distribution, to produce a set of error measurements representing the amount of the jitter.

9. The method of claim 8, further comprising multiplying said error measurements by a factor correcting for the slope of said beat signal at said one of said sampling phases and thereby converting said error measurements to numeric jitter measurements.

10. The method of claim 6, further comprising obtaining a cumulative probability distribution function for said ADC at said one of said sampling phases and determining the mean of said distribution and subtracting said mean from the value of said cumulative probability distribution function.
